(19) United States
(12) Patent Application Publication
(10) Pub. No.: US 2022/0039369 A1
(43) Pub. Date: Feb. 10, 2022

(54) ELECTROMECHANICAL PEST ANIMAL SUPPRESSION TRAP

(71) Applicant: THE UNITED STATES OF AMERICA, AS REPRESENTED BY THE SECRETARY OF AGRICULTURE, Washington, DC (US)

(72) Inventors: Aaron B. SHIELS, Fort Collins, CO (US); Jonathan C. FRAGOSO, Commerce City, CO (US); Michael C. MESSAROS, Erie, CO (US)

(21) Appl. No.: 17/394,052

(22) Filed: Aug. 4, 2021

Related U.S. Application Data
(60) Provisional application No. 63/061,217, filed on Aug. 5, 2020.

(51) Int. Cl. A01M 23/24; A01M 23/16

(52) U.S. Cl. CPC A01M 23/24; A01M 23/16

(57) ABSTRACT

Lethal wildlife traps comprising a trap compartment with an external entrance, an automatically-resetting lethal killing mechanism attached to or located within the trap container, a triggering device to actuate the lethal killing mechanism when the wildlife is positioned properly in the trap container, and an exit at the bottom of the trap container for allowing killed wildlife to fall out of the trap container to the ground or into a separate enclosure, provide economical, humane, and discreet traps for attracting and discretely killing pest species including, for example, nesting birds, rodents, and snakes; other small animals; or invertebrate species.

### BACKGROUND

Pest animals, including, without limitation, certain birds, rodents, and snakes, are found globally. Pest animals often damage resources—especially agricultural resources. Pest animal traps could be used to help protect the environment from these pests, for example, in agricultural, urban, and natural settings—practically anywhere these pest species commonly cause damage.

Animal traps of various types have long been used, ranging from the prototypical spring-loaded “mouse trap” or sticky paper trap, to complicated contraptions for ensnaring or otherwise eliminating the pest animals. Fruit fly pest traps, snail and slug pest traps, moth traps, aphid traps, wasp traps, rodent traps, and live animal cage traps are just a few of the wide assortment of pest traps on the market. Invariably, most traps, whether they merely capture the pest species, trap the pest species by holding an appendage or the body, or attempt to kill the pest species, need to be disposed of or emptied with some frequency, often requiring dispatch of a pest that remains alive but may be suffering in one way or another.

For example, U.S. Pat. No. 9,468,204 describes a trap with a kill mechanism actuated by the presence of an animal in the chamber and powered by compressed gas driving a hammer, spike, or cutting element into the chamber to strike the animal or providing a constriction mechanism to constrict around the animal for a predetermined period of time sufficient to kill the animal. The trap may be self-resetting after automatically releasing the killed animal, and preferably provides an enclosure surrounding at least part of the trap, providing an entrance for an animal, and preferably providing a bait or lure for attracting the animal.

U.S. Pat. No. 9,615,566 describes pneumatically-powered animal traps with trigger mechanisms using compressed gas to trigger a kill mechanism. U.S. Pat. No. 7,918,050 describes an extermination device with a trigger mechanism and a resilient ring mounted on a holder, intended to kill the pest in a humane manner. U.S. Patent Application Publication No. 2018/0070556 describes a device for controlling or euthanizing vermin or pests, using a completely or partially uninsulated electrically conducting wire or conductor connected to an electrical current source. New Zealand application NZ512101 describes a self-resetting pest control trap using pyrotechnics to provide a lethal blow to the pest's head and including an aperture to allow the killed animal to fall from the trap.

U.S. Patent Application Publication No. 2020/0187485 addresses a trap for killing animals such as rodents, including a cabinet with an entrance to a room in which bait is accessible and where there is a contact organ. Contact by the animal releases a spring-loaded plunger that moves through the room and kills the animal. The plunger then returns to a loaded position by means of an actuator driven by an electric motor. The entrance to the room is typically turned downward, so the animal falls down after the killing, and the trap is ready again.

U.S. Pat. No. 9,468,204 addresses an animal trap with a trigger mechanism actuated by an animal, releasing a kill mechanism powered by compressed gas. The kill mechanism preferably is configured to automatically release a killed animal and to reset to be ready for a further animal. The trap may include a suitable lure for attracting the pest animal.

The subject trap described here provides economical, reliable, reusable service, without causing the pest to suffer, and without requiring frequent maintenance. These are significant advantages over the prior art traps mentioned above.

### SUMMARY

The present subject matter for the first time provides a combination of advantages previously unknown in other pest traps: an automatically resetting, reliably lethal wildlife trap, configurable to attract specific pest vertebrates species, with an attractive box or container for attracting the pest vertebrate species and so that the lethal mechanism operates out of the public view, a trigger and skull/spine fracturing device situated so as to hold the animal in place momentarily to ensure efficient lethality, and configured to ensure that the pest vertebrate species is dead before falling through a trap door (a) to the ground where it may be carried off by another animal, or (b) into a separate collection container so as not to attract human attention or dissuade the next pest vertebrate species from entering the nest box.

The device is an automatically self-resetting wildlife trap with an opening to a cavity that is attractive to specific pest vertebrate species, designed to control such pest vertebrate species. Specifically, the lethal wildlife traps comprise a trap compartment with an external entrance; an automatically-resetting lethal killing mechanism attached to or located within the trap container; a triggering device to actuate the lethal killing mechanism when the specific pest vertebrate species is positioned properly in the trap container; and an exit at the bottom of the trap container for allowing killed pest vertebrate species to fall out of the trap container to the ground, or to fall into an attached enclosed container. Depending on the nature of the target pest vertebrate species, the device may include a separate lure compartment, either as part of the trap compartment or attached to it. The devices provide economical, humane, and discreet traps for attracting and killing specific pest vertebrate species including, by way of non-limiting example, nesting birds, rodents, and snakes.

The concept was initially developed as a response to cavity-nesting pest birds, but it is also applicable for use against other pest animals, including without limitation rodents (for example, rats and/or squirrels) and various types of snakes. Because efforts to control pest populations are generally most impactful by targeting adult breeders (and particularly removing reproducing females), this trap is ideal because it targets, for example, nesting birds that are searching for nesting cavities, or other animals that are generally curious about cavities, especially when suitable “bait” or lure is provided in or past the cavity. Thus, for example, the traps may easily be designed to target rodents of all sizes and both genders, as rodents frequently explore cavities and sheltered locations. Accordingly, in an embodiment, the cavity in each trap will be configured to be attractive to one or more pest vertebrate species of interest.

Cavities for nesting birds are often limiting in most environments, and many cavity-nesting species will not excavate their own cavity but instead will only recruit to an existing cavity. The trap design (and its artificial nest cavity when intended to attract pest cavity-nesting birds) may be configured to capitalize on the behavior of pest birds, rodents, snakes, and/or other small animals, including for example and without limitation mongoose, shrews, and voles, and/or pest invertebrate species, for example and without limitation crabs, cockroaches, spiders, scorpions, and other crustaceans or insects.
For example, a trap designed for snakes may include a separate lure compartment containing a live lure. Typically, a live lure may be accompanied by at least several days' worth of water and food, and the lure compartment would generally be separated from the trap compartment, such as with mesh, to protect the lure from a snake that enters the trap. Another example would be a trap designed for rodents, potentially including an inanimate food source in the lure compartment. Traps designed for cavity-nesting birds typically do not need a separate lure compartment—the trap itself with a round hole entrance serves as the lure for such birds.

The non-target risks can be greatly minimized, as the subject traps could be placed above ground (e.g., attached to trees, posts, buildings), away from domestic animals, typically ground dwelling domestic animals. The external entrance in the subject traps also limits the sizes and types of animals that could enter and trigger the traps. Further, the traps may be designed to take advantage of the nature of the target pest animals. For example, for pest cavity-nesting birds, there are generally few (if any) native birds that are cavity nesters in the areas where such pest cavity-nesting species are present. Designing the trap for specific cavity nesting species of birds—typically pest species—therefore should greatly the limit risk to non-target species.

One advantage to the subject traps is the potential configuration using a separate container for the collection of dead animals that have been euthanized by the subject traps. In areas where human presence is expected, or where the owner of the trap prefers to track animals captured by the trap, the separate container keeps the dead animals hidden from common view, as well as from predators who may otherwise remove a dead animal if it simply fell to the ground. Further, for certain pest species, the presence of a dead animal in or near the killing zone may tend to dissuade additional animals from exploring that portion of a trap. A configuration that separates the dead animal bodies into a separate enclosed container helps avoid these issues.

In one embodiment, the present subject matter relates to a lethal pest vertebrate species trap comprising a trap compartment with an external entrance; an automatically-resetting lethal killing mechanism attached to or located within the trap container; a triggering device to actuate the lethal killing mechanism when the pest vertebrate species is positioned properly in the trap container, and an exit at the bottom of the trap compartment for allowing killed pest vertebrate species to fall out of the trap compartment.

In another embodiment, the exit at the bottom of the trap compartment is attached to a separate enclosed container.

In another embodiment, the trap also includes a lure compartment, containing a live lure, preferably with food and water for the live lure, and typically with, for example, a screen to protect the live lure from the target species. Alternatively, the lure compartment may include inanimate food attractive to the target species.

In another embodiment, the lethal killing mechanism is a clamping device with two or more striking components, or a pithing device with one or more striking components, configured to apply a crushing blow to the head of the target species once the triggering device is tripped.

In another embodiment, the lethal killing device is powered electrically, preferably by at least one battery and/or by at least one solar cell.

In another embodiment, the trap is configured to attract nesting birds.

In another embodiment, the trap is configured to attract rodents.

In another embodiment, the trap is configured to attract snakes.

The traps described here thus provide low non-target risk in a non-toxicant and non-offensive solution to control pest wildlife—rendering them attractive and favorable to industry and consumers alike. Estimated cost per unit would be very reasonable, with minimal maintenance needed and potentially multi-year field-life of the product traps. Small property owners may need as few as 1 or 2 traps to help suppress pest wildlife problems, while larger landowners with larger numbers of pests may prefer to deploy a greater number of the traps simultaneously, especially during breeding and nesting seasons of the specific pest vertebrate species of interest.

### BRIEF DESCRIPTION OF THE DRAWINGS

FIG. 1A depicts one configuration of the trap using Jaws as the killing apparatus.

FIG. 1B depicts an alternate configuration for the Jaws.

FIG. 2A shows one set of Strike Bars usable for the Jaws as configured in FIG. 1B.

FIG. 2B shows a set of Strike Bars usable for the Jaws as configured in FIG. 1A.

FIG. 3 depicts one configuration of components for actuating and applying the Jaws, for example as configured in FIG. 1A.

FIG. 4 shows one configuration of the Sensor Housing including the Battery.

FIG. 5 shows an external view of a configuration of the access hole to the nest cavity, depicting the location of a Lure and a sensor comprising a Light Bar and a Photoresistor Strip.

FIG. 6 shows access to the programming from outside the housing.

FIG. 7 shows a view from inside the housing.

FIG. 8 shows a depiction of a self-resetting pithing device in one embodiment of the nest box.

FIG. 9 shows internal portions of a bird trap, with a perching rod above the self-setting pithing device and a trap door to allow exiting of the bird body.

FIG. 10 shows the trap and habitat box for one depiction of a snake suppression trap mounted on a pole.

FIG. 11 shows a view of the assembled trap and habitat box for one depiction of a snake suppression trap mounted on a pole as in FIG. 10.

FIG. 12 shows another view of the assembled trap and habitat box for one depiction of a snake suppression trap mounted on a pole as in FIG. 10.

FIG. 13 shows a side view of the assembled trap and habitat box for one depiction of a snake suppression trap mounted on a pole as in FIG. 10.

FIG. 14 shows a back view of the assembled trap and habitat box for one depiction of a snake suppression trap mounted on a pole as in FIG. 10.

### DETAILED DESCRIPTION OF THE PREFERRED EMBODIMENTS

The device is an automatically self-resetting lethal wildlife trap that is designed to control specific pest vertebrate species. One version may be designed to attract cavity-nesting pest birds. Other formats may be designed for use against pest rodents (e.g., rats, mice, squirrels) and/or snakes.

As used herein, the terms “animal”, “pest”, “pest animal”, “target”, “target species”. “pest vertebrate species”, and other like terms can be used interchangeably to describe any target animal or species of interest to be euthanized using the presently described lethal wildlife trap.

Some cavity nesting pest bird species that currently are known to damage agriculture in the U.S. and internationally include European Starling (Sturnus vulgaris), Common Myna (Acridotheres tristis), and parrots (family Psittacidae), including the Rose-ringed Parakeet (Psittacula krameri). Some pest rodent species that commonly damage agriculture include species in the genus Rattus, house mice (Mus musculus), and squirrels (including Sciurus carolinensis (eastern gray squirrel), and Otospermophilus beecheyi (California ground squirrel).

Because efforts to control pest populations are generally most impactful by targeting adult breeders (and particularly by removing reproducing females from the area sought to be protected), this trap is ideal because it targets, e.g., the nesting birds that are searching for nesting cavities. Cavities for nesting birds are often limiting in most environments, and many cavity-nesting species will not excavate their own cavity but instead will only recruit to an existing cavity.

In other embodiments, the trap also may be designed to target rodents of all sizes and both genders, as rodents frequently explore cavities and sheltered locations—especially if food is included in the trap, such as in a lure compartment. Target snakes may also be particularly attracted to other embodiments of the trap, especially if a bait animal is used. Accordingly, the trap design (and its artificial nest cavity) may be structured to capitalize on general behavior of the intended target, such as pest birds, rodents, and/or snakes.

The trap generally contains at least the following components:

a trap compartment configured to attract one or more pest vertebrate species, and usually to conceal the lethal action of the trap from public view;

an automatically-resetting lethal killing mechanism situated so as to humanely kill the one or more pest vertebrate species; and

a triggering device to and, for example, an exit or trap door at the bottom of the trap compartment, to release the body after a target pest vertebrate species is killed.

In addition, the trap may also be configured to include, for example, a lure compartment to help attract the one or more target species, especially for example a snake or rodent; and/or a separate enclosed collection container that is situated to receive a killed body when it passes through the exit or trap door.

One embodiment of the trap may include replaceable or interchangeable modules for various lures and/or video access. These various modules and configurations may be target species dependent.

### The Trap Generally and the Trap Compartment

The trap compartment 21 is the core part of the trap. The trap compartment is generally configured to be particularly attractive to the target species. The trap may be designed to lay on the ground, or to be attached to a pole, tree, tree branch, wall, or other suitable structure to keep the trap at a suitable height above the ground and situated so as to be most attractive to the target species.

A trap compartment generally is in the shape of a box or other container, with an external hole through which the target species enters the trap. The shape and size is variable, and will depend generally on the nature of the target species; the specific preference of the trap owner (for example, potentially to blend in to the environment or otherwise be camouflaged to avoid being conspicuous); and even the tools and supplies available to the owner or manufacturer. The trap compartment could have squared corners, rounded corners, or no corners, and usually will be designed to conceal the death of a target species from public view.

A trap compartment could be, for example, designed to attract cavity-nesting birds—typically pest species. In that situation, the trap compartment itself serves as the “lure” for cavity-nesting birds, typically searching for a pre-existing nest cavity rather than creating their own. A suitable container, with a round hole sized for the target birds, generally will itself serve as a lure to attract cavity-nesting birds.

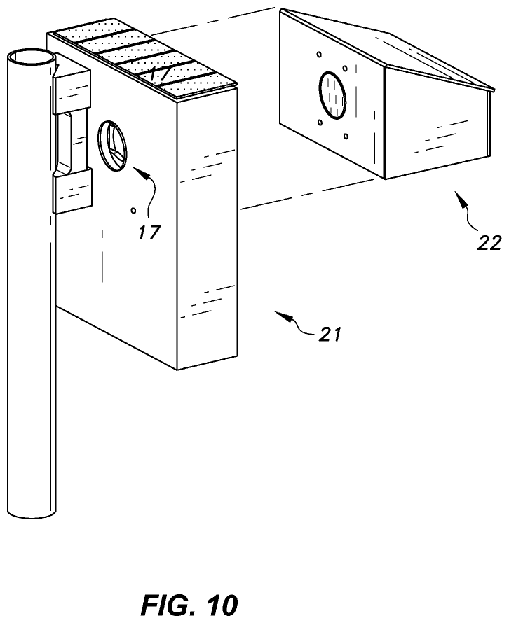

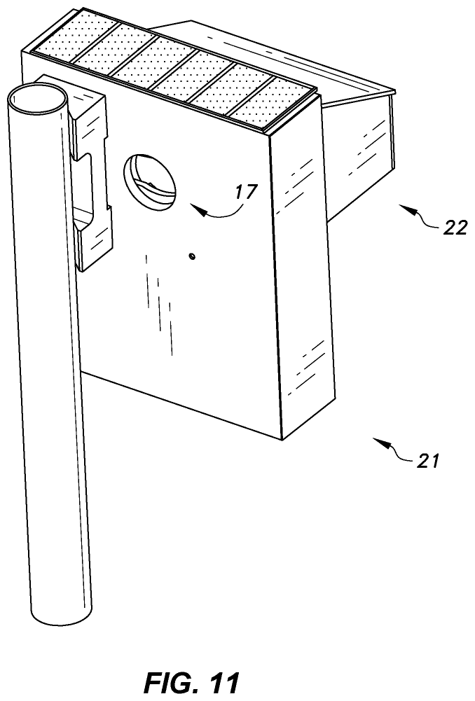

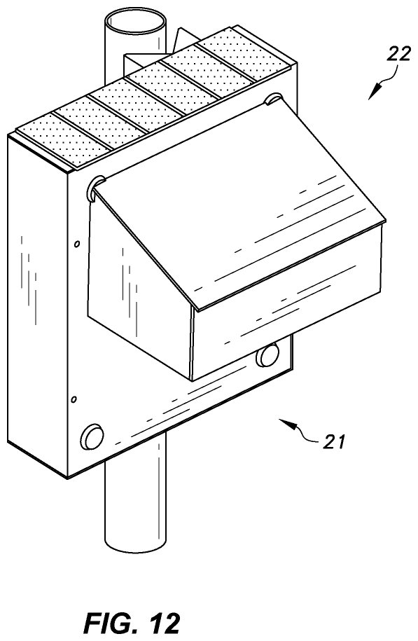

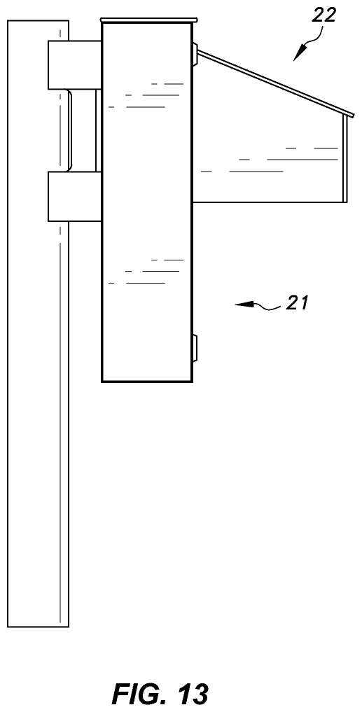

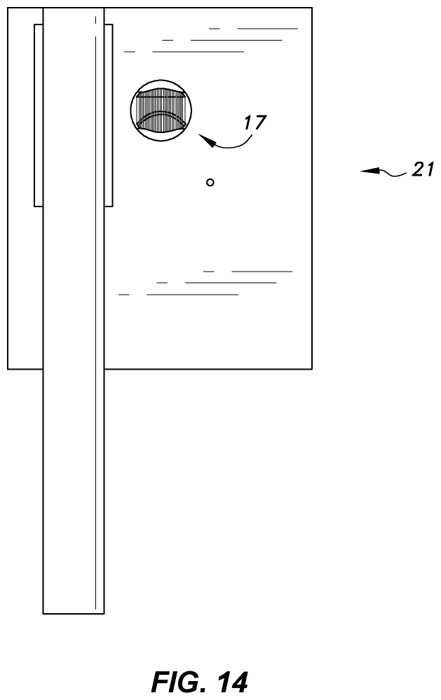

The trap compartment could include a lure 15, or it could be attached to a discrete lure container such as a habitat box 22. The lure serves to further entice the target species—especially but not limited to rodents or snakes. For rodents, the lure typically could be food placed in the trap compartment, alone or in a smaller container within the trap compartment, or in a separate lure compartment attached to the trap compartment. For snakes, the lure often could be a live animal, for example a live animal placed in a lure compartment such as a habitat box 22, usually housing the lure animal as well as food and water for the lure animal. See, for example, FIGS. 10-14. A live animal lure typically is protected from the target species, for example by a screen, so as to be able to maintain the animal lure for multiple target animals rather than allow the lure to be eaten by the first target that enters the trap. See, for example, FIGS. 10 and 14.

The trap compartment may be constructed of any reasonable material suitable to the particular intended use. The trap—including the trap compartment and any other compartments attached to the trap compartment—should be reasonably sturdy, able to withstand multiple uses with the target species (and any live lure animal that may be included), and the particular environment contemplated for using the trap. By way of non-limiting example, the trap compartment and other parts of the trap may be constructed of wood, metal, plastic, fiberglass, or other suitable material. Construction generally may use any suitable combination of screws, nails, glue, hinges, or other construction.

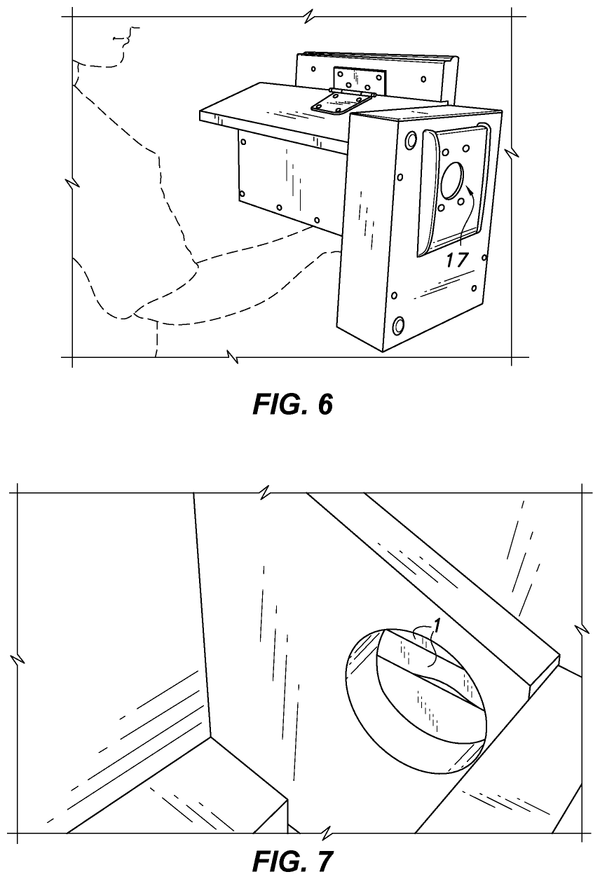

The design of the trap compartment, and the rest of the trap, should include any features needed to provide convenient access to any parts of the trap that may be needed during repeated use and maintenance of the trap over any expected period of time using the trap. This may include, as needed and, by way of non-limiting example, a hinged or removably fitted side or top, or other means to open the trap compartment or any other part of the trap to allow access to the interior as needed, whether for cleaning, refreshing a lure or food and water for a lure animal, or any other purpose. See, for example, FIG. 6.

The trap compartment also is associated directly with the automatically-resetting lethal killing mechanism. The killing mechanism may be located inside the trap compartment, contiguous to the trap compartment, or in an adjacent compartment attached to the trap compartment.

### The Automatically-Resetting Lethal Killing Mechanism

The automatically-resetting lethal killing mechanism works in combination with the trap compartment to trap a target animal, to entice the animal to a position that triggers actuation of the killing mechanism. Together, there are generally five design elements that operate together in the primary operation of the trap: the killing mechanism, the loading mechanism, the sensor, the housing, and the controls hardware.

The killing mechanism is generally designed and situated in the trap to quickly kill the target species by applying a crushing blow to the head or spinal cord of the animal. The killing mechanism may be, by way of non-limiting example, a spring-loaded clamping device with two striking portions designed to close violently around the animal's head or neck, or a pithing device including one striking portion designed to violently striking the animal's head or neck, thereby piercing or severing the animal's spinal cord or lethally damaging the animal's brain.

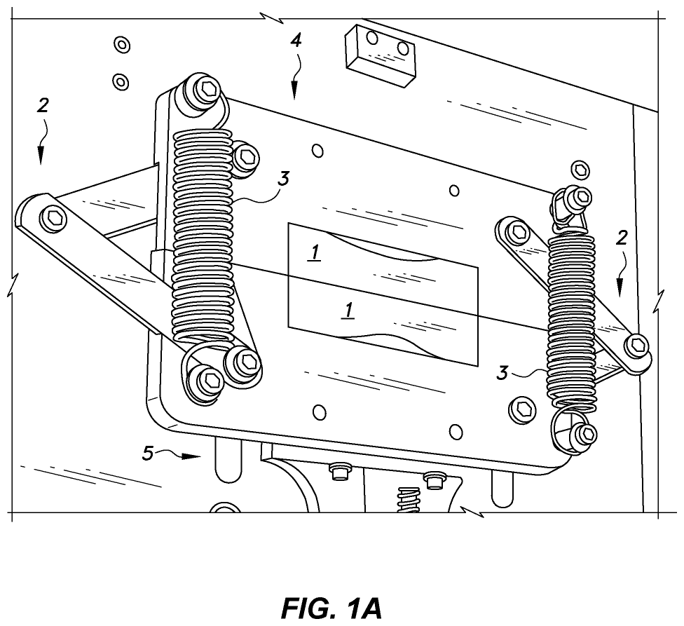

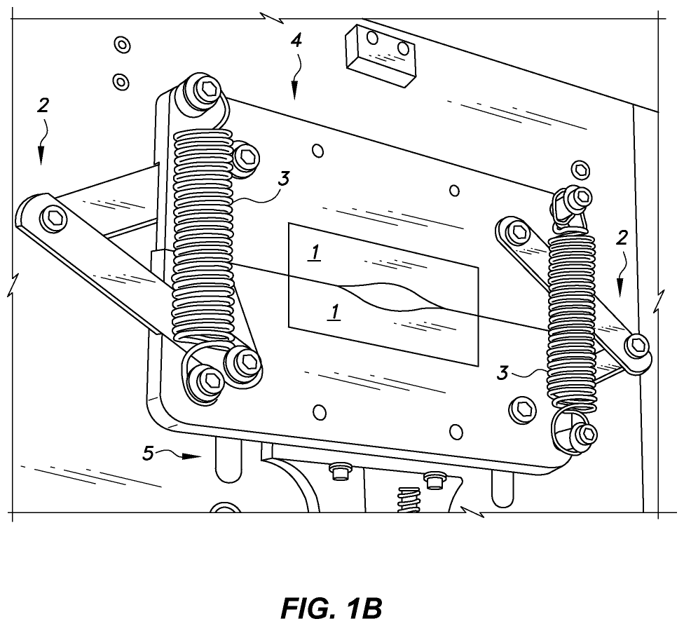

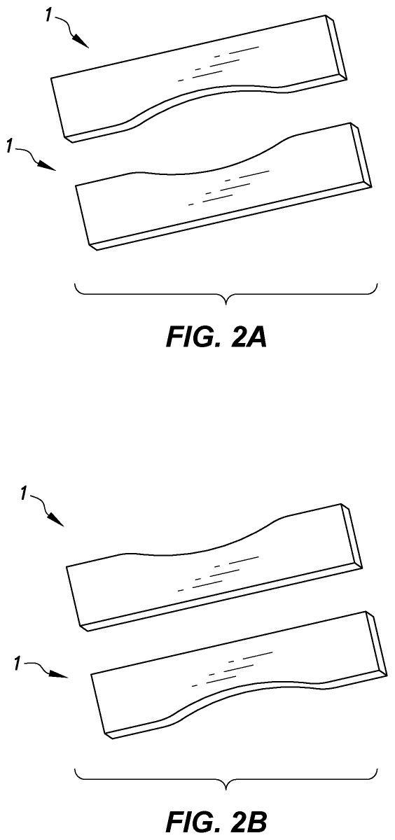

One version of the killing mechanism is depicted in FIGS. 1A and 1B. In this version, a clamping device uses spring-loaded “jaws”—a pair of strike bars 1—to violently clamp shut on the animal's head or spinal cord when the animal enters or starts to enter the area adjacent to the killing mechanism. Depending on the intended species and the expected contact points on the animal, the striking surface of each strike bar may be, for example, relatively flat, as in FIGS. 1A and 2B, or may be concave, as in FIGS. 1B and 2A. Of course, other versions could include one or more strike plates with a striking surface that is convex, depending on the intended use and results. Both strike plates do not need to have the same shape—for example, one strike plate could be flat, and the other concave.

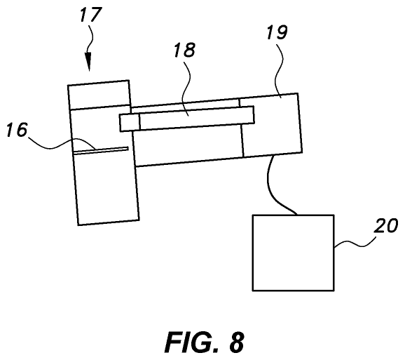

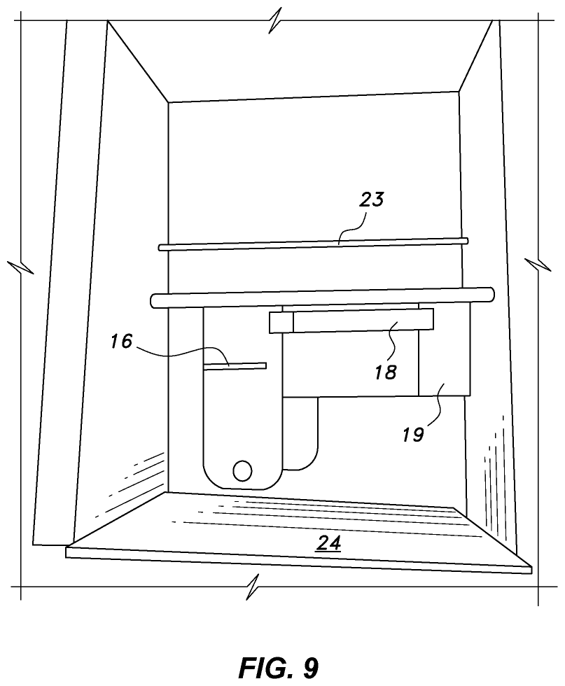

Another version of the killing mechanism is depicted in FIGS. 8 and 9. A pithing device, such as a spring-loaded bolt, may use a single striking component designed to violently strike the target animal's head or spinal cord, thereby piercing or severing the animal's spinal cord or fatally injuring the animal's brain. See, for example, the bolt 18 in FIGS. 8 and 9.

The killing mechanism is generally designed to provide quick, humane killing of a target animal, preventing significant suffering from the animal. Proper configuration of the killing mechanism is critical to be sure to strike the animal in an accurate, lethal, humane manner. Typically, the killing mechanism is configured to maintain the struck position, holding the animal body in place, for a period of time, such as for example a few seconds, to help ensure the animal is dead before the killing mechanism releases the body.

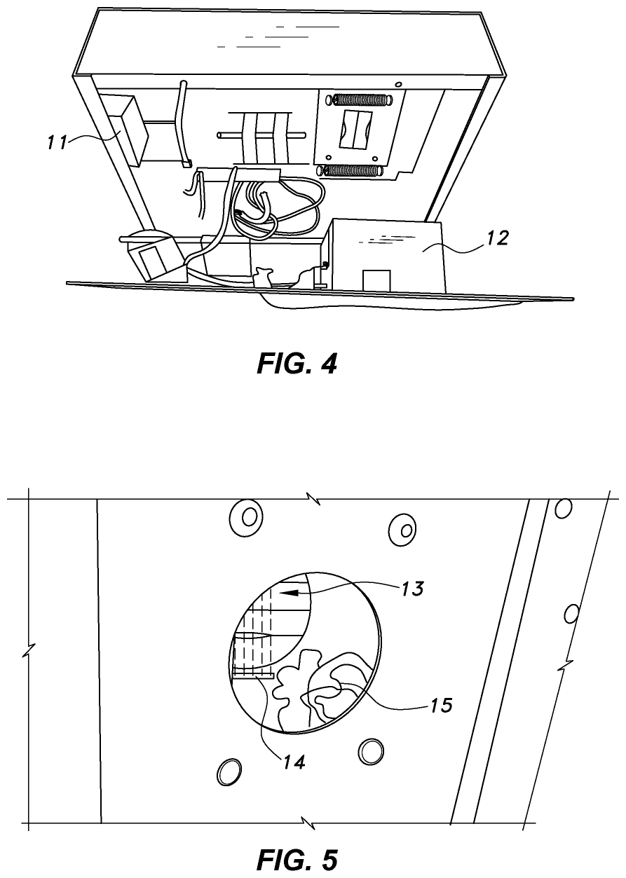

The killing mechanism typically is automatically self-resetting, and often powered at least in part by an AC or DC source of electricity. See, for example, the power supply 20 in FIG. 8, or the battery 11 in FIG. 4. Electric power may be supplied in whole or part by a battery located inside or outside the trap; by hard wire to an AC power supply; by solar power; or any other power source reasonable to the particular situation and intended use. Of course, other sources of power besides electricity may also be useful in whole or part depending on the circumstances and location of the particular intended use.

### Example 1—Trap Configuration Using Two Strike Bars

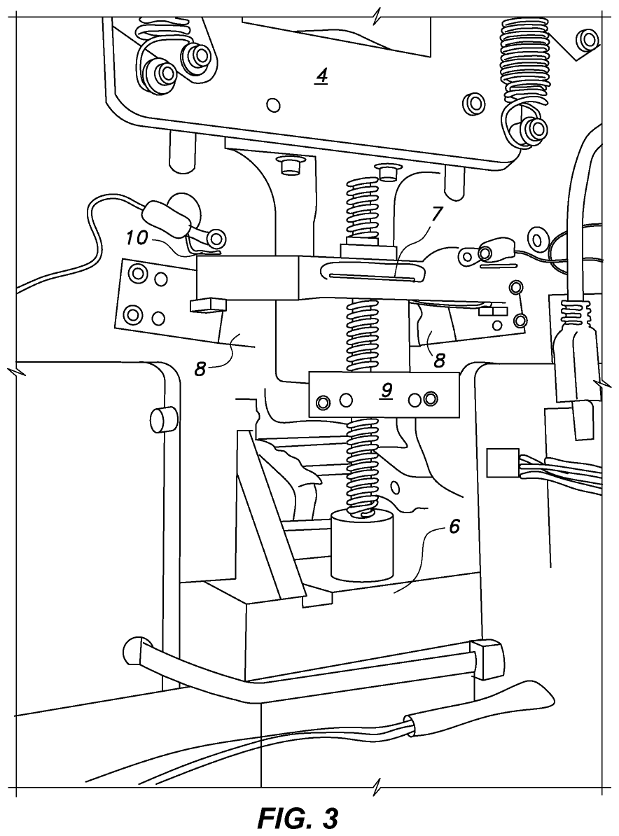

In one configuration depicted in FIGS. 1A, 1B, and 3, the trap includes a killing mechanism using two strike bars 1 mounted on a base plate 4. The “jaws” mechanism operates as a parallel linkage mechanism 2, wherein a pair of opposing upper and lower strike bars are moved in a parallel and opposite motion, violently closing on the target animal's head or neck. See FIGS. 1A, 1B. In this configuration, once the killing mechanism is actuated by the triggering mechanism (having been activated by the animal), the springs 3 drive the strike bars 1 toward each other at a rapid speed. Here, the strike bars are designed to be removable and reconfigurable, based on species, behavior, and/or preferred strike position on the animal. The parallel motion of the strike bars is smoothly guided (and limited laterally) by the Roller Hardware 5.

Loading Mechanism

The loading mechanism for this exemplary configuration is located contiguously to the “jaws” elements, as depicted in FIG. 3. A linear actuator 6 causes the release bar 7 to travel up and down, parallel to the motion of the strike bars. In the downward motion, the release bar pulls the jaws apart and open to their full open position. As in a firearm, a sear acts to hold the striker back until the striker is released upon discharge of the weapon. Similarly, here the sears 8 engage with the draw plate 9 once the jaws are opened to the full open position, thereby holding the jaws open. The linear actuator 6 then reverses direction, moving upward until the release bar 7 contacts both sears 8. When the system is ready to be actuated, the linear actuator 6 drives the release bar 7 upward, forcing the sears 8 to disengage the draw plate 9 and release the jaws with the strike bars to spring towards each other rapidly and violently.

Once the system is actuated and the jaws and strike bars clamp shut, the mechanism is ready to draw the jaws apart again and open them to the full open position. In this exemplary configuration, when the release bar 7 makes contact with both sears 8, a contact 10 forms an electrical circuit that can be detected by the control system, discussed further below.

Sensor and Trigger

The sensor may be contained, for example, in a sensor housing 12 on the far side of the killing mechanism. See, for example, FIGS. 5 and 6. This particular embodiment includes a trigger using a sensor with a light bar 13, and a photoresistor strip 14, in combination with a lure 15. See FIG. 5. The light bar 13 emits an array of light, here green light downward, and the photoresistor strip 14 spans the width of the opening (see FIG. 5)—here, the photoresistor strip 14 has a length of six photoresistors. The light bar 13 and photoresistor strip 14 in this embodiment are contained in the sensor housing 12. See FIG. 4. Of course, the sensor may be configured for different forms of light, by way of non-limiting example, red light, infrared light, or white light, as may be appropriate or desired for the circumstances and intended use.

Any object—such as a target animal—that enters the opening creates a shadow across the photoresistor strip 14, thereby changing the value that is read by the control system. The shadow value correlates to the width of the object that broke the plane of the sensor light, enabling the system to differentiate between a small width portion of an animal, such as a beak or nose, and the creature's head. When a shadow of predetermined size breaks the plane of the sensor light, the target animal's head is properly located within the trap and the trigger is immediately activated, actuating the killing mechanism while the animal's head is in an optimum position for a true, lethal, and humane blow to the animal.

The sensor housing 12 may also have a full length through hole so that any lure placed in the far end is in view of the target animal, helping to encourage it to investigate further inside the trap, thereby reaching optimum position for triggering the killing mechanism.

In one embodiment, the sensor housing 12 may be an aluminum electronics box with an access hole and mounting provisions. See, for example, FIGS. 4 and 5. Of course, the sensor housing 12 may be constructed of any suitable material, as with construction of the rest of the components of the trap.

Sensor Housing

The sensor housing 12 typically houses the electronics for the sensor and has an access hole for the target animal. In one configuration, the sensor housing is mounted to the side of a trap compartment, though it may be configured however seems appropriate considering the target species, the structure of the trap compartment, the intended orientation, and the contemplated environment for using the trap. In the configuration discussed above, the trap will fire on anything that makes a significant enough shadow in the sensor. See, for example, FIGS. 4-7.

The sensor housing 12 typically contains the trap, the battery (if power is supplied by battery), the control system, and other wiring. Of course, the trap may be configured so that any or all of these components are contained in other parts of the trap besides the sensor housing.

If the trap is powered by a rechargeable battery, an outlet may be included in the housing or elsewhere in the trap to provide easy access for recharging the battery. Typically, there may also be an on/off switch to turn the trap on or off; indicator LEDs to indicate the system's status; and/or a USB port to allow access to the programming without need to disassemble the sensor housing or other parts of the trap. In one embodiment, it may be preferable for the sensor housing to include or be connected to solar cells that recharge the battery over time, rather than needing to be recharged by an outlet or wire connection to an external power source.

The sensor housing (or other part of the trap) may include a transparent, removeable or openable window that serves as access for placing a lure, and/or facilitates video or monitoring of activity inside the trap.

Control System/Control Hardware

A mechanical or electronic control system may be used to manage, direct, or regulate the trigger sensitivity and thereby actuation of the trap killing mechanism. For example, the control system may allow for programming the minimum size of a shadow across a photoresistor strip that would trigger actuation of the killing mechanism, so as to prevent premature or unnecessary actuation. A control system could be configured to be as simple as a device to program the sensitivity of the trigger, or to be as complicated as identifying particular target species that may allow actuation of the killing mechanism.

Any suitable mechanical or electronic control system may be used in the trap, depending on the particular species, environment, and intended capabilities of the trap for the particular contemplated use.

### Example 2—Use of a Pithing Device as Killing Mechanism

Another embodiment of the trap may use a pithing device or any other single striking component, designed to violently strike the target animal's head or spinal cord to pierce or sever the spinal cord or fatally injure the animal's brain. This could be simply by striking the animal hard enough with the striking component, or by crushing the animal's head or spine between the single striking component and a wall or other surface of the trap. See, for example, FIGS. 8 and 9.

As depicted in FIGS. 8 and 9, one configuration of a trap with a single striking component includes an opening 17 for attracting the target species; a trigger 16 for activating the killing mechanism; a bolt 18 as the single striking component; and the mechanical action 19 for releasing and retracting the bolt 18. The trap may also include a perching rod 23. Typically, the trap will also contain a battery or connection to a power supply 20 for powering the mechanical action.

FIG. 8 shows the entrance hole or opening 17 that may be used to attract the target species to enter the trap. The size of the entrance hole may be adjusted to best attract the particular target species. FIG. 8 depicts the location of the self-resetting pithing device on the other side of the entrance hole 17. See also FIG. 9. When the target animal passes through the hole (or at least the head of the target animal passes sufficiently through the hole), the trigger 16 is tripped, thereby actuating the mechanical action 19 and striking the animal's head with the bolt 18.

As depicted in FIG. 9, the bottom of the trap 24 may include a spring-loaded trap door or other exit to facilitate allowing the animal carcass to exit the trap compartment. The exit may allow the animal to fall to the ground outside the trap or may connect to a collection container to hold the killed animal either for observation purposes or simply to hide the dead animal from public view.

### The Trigger or Triggering Device

The trigger or triggering device may be any suitable component that initiates or precipitates activation of the killing mechanism once the trigger or triggering device is tripped by a target species sufficiently to meet or exceed any predetermined threshold programmed into the trap. The trigger or triggering device may be, by way of non-limiting example, a mechanical switch or lever that is tripped when the animal brushes past it; a light source and receptor that detects interruption of the light detected by the receptor when the animal is present; an electric current that is interrupted by physical interaction with the target animal; or any other trigger that reasonably detects the presence of a target in the kill zone of the trap. FIG. 5 depicts an example with a light source trigger. The trigger or triggering device is generally situated so as to be activated when the animal is present sufficiently in the kill zone of the killing mechanism to help ensure a swift, lethal, and humane execution of the killing mechanism.

The Exit from the Trap Compartment

The trap generally includes an exit from the trap compartment, to release the body of a target animal after it is killed by the killing mechanism. The exit may be, for example, a sufficiently-sized hole at the bottom of the trap compartment, or a trap door that easily allows the killed animal to fall through. The animal could be allowed to fall to the ground outside the trap, or could be directed from the exit to an optional collection container, as described further below.

### An Optional Lure Compartment

Depending in large part on the target species, the trap may include an optional lure compartment to further attract the target animals. For example, a trap designed to capture and kill rodents may include food in the trap, perhaps in a separate lure compartment so that the food does not fall through the exit at the bottom of the trap compartment. A trap designed to capture and kill snakes could include a lure compartment, such as a habitat box 22, to contain a live animal lure typically with food and water to maintain the live animal for a period of time before the trap owner needs to replenish the animal's supplies. In that event, typically a screen would seal off the lure compartment or habitat box 22 so as to protect the live animal lure from the target animals that enter the trap compartment. The habitat box 22 or live lure compartment would be situated to be sure a snake, for example, can detect and try to pursue the live animal lure, though without the ability to actually attack or eat the live animal lure.

### An Optional Collection Container

As noted above, another optional attachment to the trap is a separate collection container that is situated to receive a killed body rather than allow it to simply fall to the ground outside the trap. Such a separate collection container can serve different purposes, ranging from keeping dead animal bodies from ready view by any nearby persons or other targets of interest, to facilitating tracking by the trap owner of the number and type of targets captured and killed by the trap. Bodies that simply are allowed to fall to the ground may be, depending on the environment, eaten or otherwise carried away by other animals, largely preventing accurate tracking of the trap's efficacy.

### Example 3—Pest Cavity-Nesting Birds

This example provides a trap suitable for attracting and killing pest cavity-nesting birds.

1—A cavity-nesting bird is attracted to the trap compartment or nest box through a circular-hole entrance. This configuration tends to be very attractive to cavity-nesting birds.

2—Inside the nest box is an automatically self-resetting trap that includes a trigger actuated by the presence of the bird, causing, for example, the jaws (including metal plates or strike bars) to provide a sharp crushing blow to the head when the bird triggers the trap. Importantly, the trigger and skull/spinal-fracturing device is situated in a way that orients the bird so that lethality occurs efficiently (i.e., causes sufficient skull or spinal fracture to result in death within a very short time, minimizing or avoiding suffering by the animal). Bait or a lure can be added to the trap, in the trap compartment or in an attached lure compartment, to further attract the pest species, and to help ensure that the bird places its head in the proper area of the trap for the metal plates or strike bars of the jaws to violently strike the bird's head as soon as the kill mechanism is actuated by the trigger.

3—Typically the jaws are configured to maintain the clamped position of the metal plates or strike bars on the bird's head for a period of time, such as for example a few seconds, to help ensure that the bird has been euthanized before the body is released by the jaws. Once the bird is euthanized and the jaws release the body inside the nest box, the body will fall to the bottom of the nest box, through an exit such as, for example, a hole or causing a trap-door to open, typically by the weight of the dead bird's body. The bird will fall outside the nest box onto the ground, or into a chute or through a passage that will deliver the bird's body into a collection container if one is attached to the trap. In many remote areas, bird carcasses deposited on the ground will not attract human attention or offend human sensitivity and may simply be carried off or eaten by other animals in the area. In areas where human contact is prevalent, or if the trap owner wishes to see each carcass first-hand or otherwise monitor the efficacy of the trap, then use of a chute or passage to a separate container may be most appropriate. Likewise, use of a chute or passage to a separate container may be appropriate to prevent further targets of interest to be dissuaded from entering the trap.

4—Once the trap has triggered, euthanized the pest species, and cleared the carcass, the strike bars or metal plates are automatically retracted (by way of non-limiting example, by electricity from battery or plug-in power source) and thus reset for another triggering event by the next animal attracted to the trap.

An alternative way to use the trap with a food lure would be as a lethal feeder for wildlife rather than positioning it at a bird nesting location as a lethal nest box. This would allow all wildlife (cavity- and non-cavity seeking pests) to be targeted. Further, instead of only targeting reproductively active individuals searching for a nest cavity, individuals could be attracted to the trap year-round if it had a lure or food reward situated to attract the birds as well as help ensure proper head-orientation within the trap compartment to facilitate the killing blow. Again, these configurations take advantage of the behavior of the target wildlife species so they can be properly and humanely euthanized.

The nest box type of device is easily configured to be more species-specific than a non-nest box trap design, and therefore more conducive to keeping non-target species from being impacted by the trap.

### Example 4—Pest Snakes

FIGS. 10-14 depict various views of an exemplary trap configured to attract and kill snakes, including at least a trap compartment 21 and a habitat box or lure compartment 22. The trap compartment is the larger container so as to fit as much as possible of a snake that enters the trap. A screened-off habitat box or lure compartment 22 is attached to the trap compartment 21 so as to entice the snake with a live animal lure, but without allowing the snake to actually harm the live animal lure. Power for the trigger and killing mechanism could be provided by an internal or external battery, solar cells, or wiring to an external AC power source or other power source.

In this embodiment, a live lure, by way of non-limiting example, a mouse or chick, is safely contained in the habitat box 22 with sufficient food and water to maintain the lure animal until the next scheduled maintenance visit by the trap owner. By way of non-limiting example, sufficient food and water could be included to allow maintenance to be scheduled approximately once a week.

The snake can visually observe the live animal lure, by way of non-limiting example through the screened front window of the trap compartment and/or the screened rear window of the habitat box. As the snake enters the trap aperture attempting to gain access to the lure, the trigger is activated, for example when the snake's head breaks an IR light beam, thereby discharging the killing mechanism and crushing the snake's head between two strike bars or hitting the snake's head with a single strike component, thus killing the snake quickly and humanely. An additional screened window could be included to improve quality of life for the lure by providing better lighting and/or more air flow. The snake's body could be allowed to fall through an exit at the bottom of the trap compartment to the ground outside the trap, or into a separate collection compartment located in the bottom of, or attached to, the trap compartment.

### Example 5—Pest Rodents

Another embodiment could be configured for rodents. It may be preferable to include a “food source module” baited with, by way of non-limiting example, a long-life/low-maintenance nutrition bar that could be mounted in place of the habitat box, with the only visible access offered via the trap aperture. The food source could be either screened from access by the rodent or plainly accessible to the rodent. In seeking the food via the trap aperture, the rodent's head would set off the trigger, for example by breaking an IR light beam, activating the killing mechanism to violently strike the rodent's head with one or two strike bars or plates, thus killing it quickly and humanely. Again, the body could then be allowed to fall through the exit of the trap compartment, either to the ground outside the trap or to a separate collection compartment, as deemed warranted by the trap owner.

### CONCLUSIONS

These results demonstrate the effective, convenient, and economical approach in constructing a humane, electromechanical self-resetting pest animal suppression trap configurable for various pest species and environments.

It is to be understood that the new apparatus and its use described here are not limited to the specific embodiments described above, but instead encompass any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A lethal wildlife trap comprising
a trap compartment with an external entrance configured to attract a specific pest vertebrate or invertebrate species,
an automatically-resetting lethal killing mechanism attached to or located within the trap compartment,
a triggering device to actuate the lethal killing mechanism when the specific pest vertebrate species is positioned properly in the trap compartment, and
an exit at the bottom of the trap compartment for allowing a body of a killed pest vertebrate species to fall out of the trap compartment.

2. The lethal wildlife trap according to claim 1, wherein the exit is attached to a separate enclosed compartment.

3. The lethal wildlife trap according to claim 1, wherein the trap further comprises a separate lure compartment.

4. The lethal wildlife trap according to claim 3, wherein the lure compartment contains a live lure.

5. The lethal wildlife trap according to claim 4, wherein the lure compartment also contains food and water for the live lure.

6. The lethal wildlife trap according to claim 3, wherein the lure compartment contains food.

7. The lethal wildlife trap according to claim 5, wherein the trap further comprises a screen separating the lure compartment and the trap compartment.

8. The lethal wildlife trap according to claim 1, wherein the lethal killing mechanism comprises a clamping device with two or more strike components configured to kill the pest vertebrate or invertebrate species once the triggering device is tripped and the lethal killing mechanism is actuated.

9. The lethal wildlife trap according to claim 1, wherein the lethal killing mechanism comprises a pithing device with one or more striking components configured to kill the pest species.

10. The lethal wildlife trap according to claim 1, wherein the lethal killing mechanism is powered electrically.

11. The lethal wildlife trap according to claim 10, wherein the electrical power is provided by a power source comprising at least one battery.

12. The lethal wildlife trap according to claim 10, wherein the electrical power is provided by a power source comprising at least one solar cell.

13. The lethal wildlife trap according to claim 1, wherein the trap is configured to attract a nesting bird.

14. The lethal wildlife trap according to claim 1, wherein the trap is configured to attract a rodent or other small animal.

15. The lethal wildlife trap according to claim 4, wherein the live lure is a small animal, and the trap is configured to attract a snake.

16. The lethal wildlife trap according to claim 5, wherein the live lure is a small animal, and the trap is configured to attract a snake.

17. The lethal wildlife trap according to claim 13, wherein the nesting bird is at least one selected from the group consisting of starlings, mynas, parrots, and parakeets.

18. The lethal wildlife trap according to claim 14, wherein the rodent is at least one selected from the group consisting of rats, mice, and squirrels.

19. The lethal wildlife trap according to claim 17, wherein the trap further comprises a separate lure compartment containing inanimate food.

20. The lethal wildlife trap according to claim 1, wherein the trap compartment with the external entrance configured to attract the specific pest vertebrate or invertebrate species comprises a cavity designed to be attractive to the specific pest species, and to conceal the action of the lethal killing mechanism from public view.
